(19) United States
(12) Patent Application Publication
(10) Pub. No.: US 2025/0351772 A1
(43) Pub. Date: Nov. 20, 2025

(54) LIFTING SYSTEM FOR AN AGRICULTURAL IMPLEMENT

(71) Applicant: MACDON INDUSTRIES LTD., Winnipeg (CA)

(72) Inventors: Matthew J. Stephens, Niverville (CA); Neil Barnett, LaSalle (CA); Brent Gabriel, Winnipeg (CA); Vlad Kowalyk, Winnipeg (CA)

(21) Appl. No.: 19/208,883

(22) Filed: May 15, 2025

Related U.S. Application Data
(60) Provisional application No. 63/647,697, filed on May 15, 2024.

(51) Int. Cl. A01D 34/24; A01D 34/04

(52) U.S. Cl. CPC A01D 34/24; A01D 34/04

(57) ABSTRACT

A lifting system for an agricultural implement having a carrier frame and a header frame includes a float link, a sliding link, and a limiter link. The float link has a first end pivotably coupled to the carrier frame and a second end pivotably coupled to the header frame to movably couple the header frame to the carrier frame. The sliding link has a first end operably coupled to the header frame and defines a guide slot proximate a second end. The limiter link has a first end movably coupled to the guide slot and a second end spaced from the first end. The limiter link is pivotably coupled to the carrier frame between the first end and the second end and is movable to control relative movement between the header frame and the carrier frame.

### CROSS-REFERENCE TO RELATED APPLICATIONS

The subject patent application claims priority to, and all the benefits of, U.S. Provisional Patent Application No. 63/647,697, filed on May 15, 2024, the entire contents of which are incorporated by reference herein.

### BACKGROUND

Crop harvesting headers may be coupled to the front of a tractor using a traditional three-point hitch. The three-point hitch is operable to raise and lower the harvesting header during use to clear obstacles or for transportation between fields. Some harvesting headers may include a float system, which allows the header to move up and down independently of the three-point hitch and tractor in order to avoid obstacles and follow the contours of the ground during harvest. However, a float system with a large amount of float travel may reduce the maximum height that the tractor is able to lift the header. Therefore, a lifting system able to increase the maximum height that a header can be lifted is desired.

### SUMMARY

In a first aspect, an agricultural implement is provided for use with an agricultural machine and includes a carrier frame and a header frame. The carrier frame is configured to be coupled to the agricultural machine and the header frame includes a cutter bar. The agricultural implement further includes a float link having a first end pivotably coupled to the carrier frame and a second end pivotably coupled to the header frame to movably couple the header frame to the carrier frame. The agricultural implement further includes a sliding link and a limiter link. The sliding link has a first end operably coupled to the header frame and defines a guide slot proximate a second end. The limiter link has a first end movably coupled to the guide slot and a second end spaced from the first end. The limiter link is pivotably coupled to the carrier frame between the first end and the second end and is movable to control relative movement between the header frame and the carrier frame.

In a second aspect, a lifting system is provided for an agricultural implement having a carrier frame and a header frame and includes a float link, a sliding link, and a limiter link. The float link has a first end pivotably coupled to the carrier frame and a second end pivotably coupled to the header frame to movably couple the header frame to the carrier frame. The sliding link has a first end operably coupled to the header frame and defines a guide slot proximate a second end. The limiter link has a first end movably coupled to the guide slot and a second end spaced from the first end. The limiter link is pivotably coupled to the carrier frame between the first end and the second end and is movable to control relative movement between the header frame and the carrier frame.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is an environmental view of a rotary mower attached to a tractor.

FIG. 2 is a side view of the rotary mower and tractor of FIG. 1, showing the rotary mower in a lowered position.

FIG. 3 is an enlarged side view of the rotary mower and tractor of FIG. 1 in the lowered position.

FIG. 4 is an enlarged side view of the rotary mower and tractor of FIG. 3 in a raised position.

FIG. 5 is a rear perspective view of the rotary mower of FIG. 1 removed from the tractor and in the lowered position.

FIG. 6 is a side view of the rotary mower of FIG. 5 in the lowered position and removed from the tractor.

FIG. 7 is a side view of the rotary mower of FIG. 5 in the raised position.

FIG. 8 is a bottom view of the rotary mower of FIG. 5.

FIG. 9 is a cross-sectional view of the rotary mower along line 9-9 in FIG. 8 in the lowered position.

FIG. 10 is a cross-sectional view of the rotary mower along line 9-9 in FIG. 8 in the raised position.

FIG. 11 is an enlarged perspective view of the rotary mower of FIG. 5 in a raised position and showing a top link receiver and a first implementation of a guide mechanism.

FIG. 12 is an enlarged side view of the rotary mower of FIG. 6 in the raised position and showing the top link receiver and the guide mechanism.

FIG. 13 is a fragmentary perspective view of the top link receiver and the guide mechanism of FIG. 12 in the lowered position.

FIG. 14 is a fragmentary perspective view of the top link receiver and the guide mechanism of FIG. 12 in the raised position.

FIG. 15 is an enlarged perspective view of the rotary mower of FIG. 5 in a raised position and showing the top link receiver and a second implementation of the guide mechanism.

FIG. 16 is an enlarged side view of the rotary mower in the raised position and showing the top link receiver and the guide mechanism of FIG. 15.

FIG. 17 is a fragmentary perspective view of the top link receiver and the guide mechanism of FIG. 15 in the raised position.

FIG. 18 is a schematic of a control system for the rotary mower showing a controller and a control valve.

### DETAILED DESCRIPTION

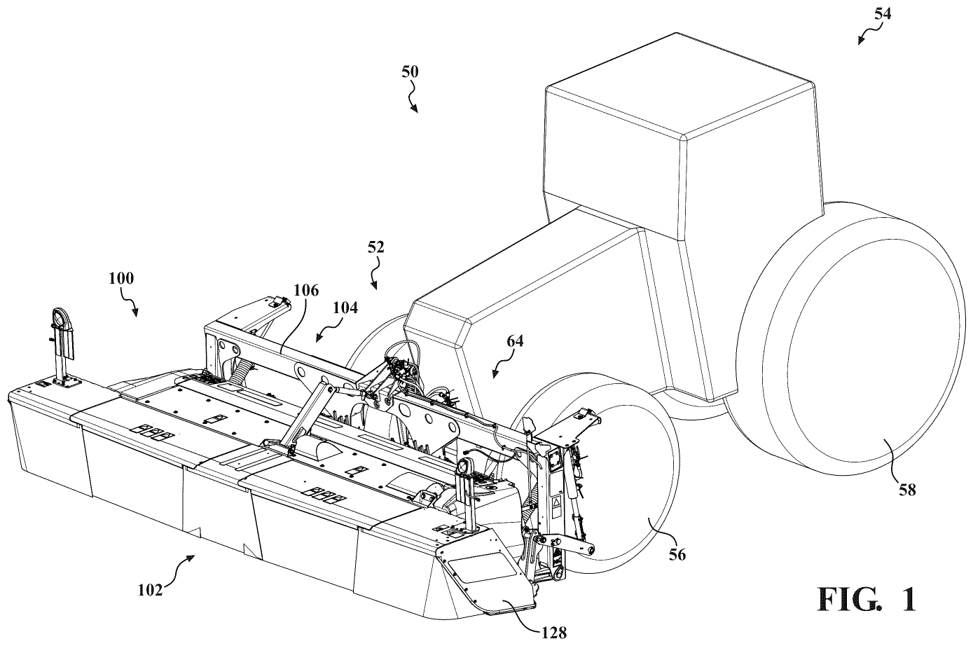

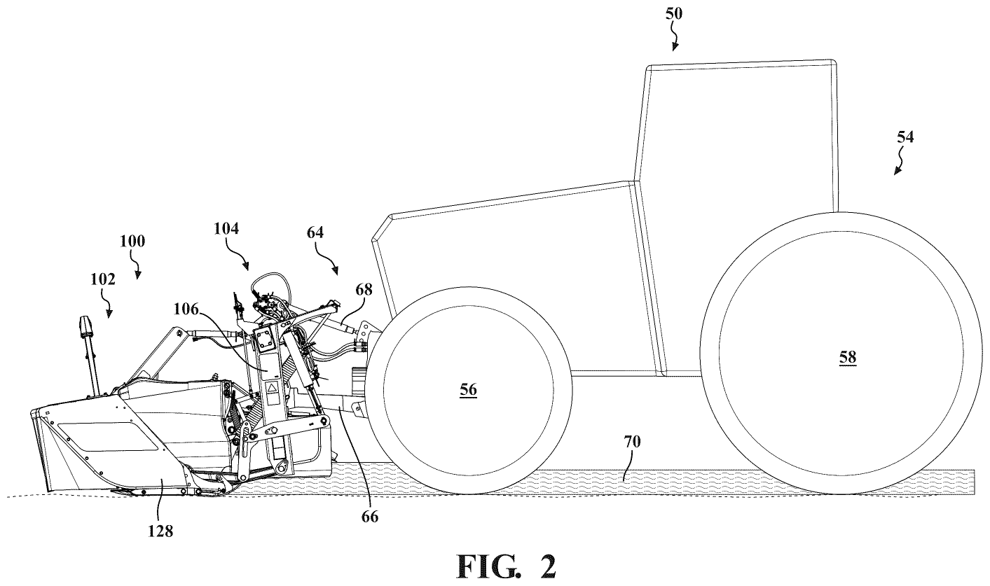

In FIGS. 1-4 an agricultural implement 100 for harvesting crops is shown coupled to an agricultural machine, such as a traditional style tractor 50. In general, the tractor 50 has a front 52 and a rear 54 associated with forward and reverse directions of travel. The tractor 50 illustrated herein includes front wheels 56 and rear wheels 58 arranged proximate the corresponding front 52 and rear 54 thereof. It will be appreciated that the tractor 50 may be configured as shown with wheels, or may utilize other propulsion configurations such as tracks, or a combination of tracks and wheels (not shown). Best shown in FIG. 1, each of the front wheels 56 is arranged on one side of the tractor 50 and laterally spaced from the other. Similarly, each of the rear wheels 58 is arranged on one side of the tractor 50 and laterally spaced from the other.

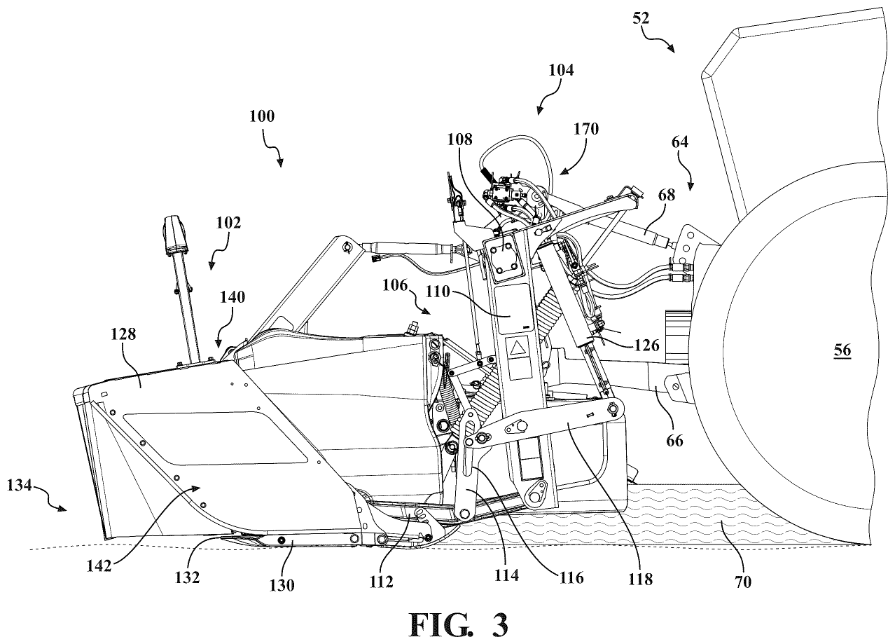

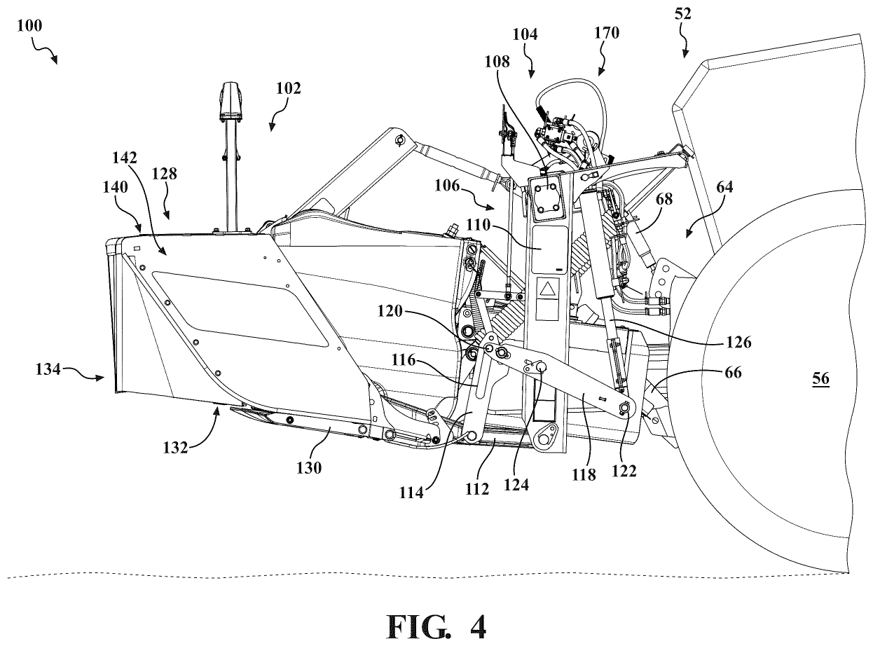

The tractor 50 is used to operate and control the agricultural implement 100 by providing power, via a tractor PTO system. The tractor 50 may further include a hydraulic system, which pumps hydraulic fluid to the agricultural implement 100, and is utilized to actuate and control various components of the agricultural implement 100, as will be discussed below. The tractor 50 further includes a hitch 64 arranged at the front 52 to couple the agricultural implement 100 to the tractor 50. Here, the hitch 64 is a three-point hitch, which includes a pair of lifting arms 66 and a top link 68. The lifting arms 66 may be powered by the hydraulic system to pivot between a raised position (FIG. 4) and a lowered position (FIG. 3) for controlling a height of the agricultural implement 100 above the ground. The top link 68 controls the angle of the agricultural implement 100 as it is lifted and lowered, and typically has an adjustable length which may be controlled manually or hydraulically. The lifting arms 66 carry the agricultural implement 100 and are controllable by an operator to raise or lower the agricultural implement 100 during use.

The agricultural implement 100 illustrated herein is a rotary mower 100. The rotary mower 100 includes a header 102 and a carrier 104. The carrier 104 is coupled or mounted to the hitch 64 of the tractor 50 and supports the header 102 during operation. The header 102 is movably coupled to the carrier 104 to facilitate independent movement of the header 102 relative to the carrier 104 and the tractor 50. During use, the header 102 is pushed along the ground by the tractor 50 and is able to float relative to the carrier 104 and closely follow contours of the ground to maintain a steady height above the ground. The floating action of the header 102 allows the header 102 to move independently of the tractor 50 such that movement of the tractor 50 does not influence the height of the header 102, which facilitates consistent cut height when harvesting crops. Crops that have been cut by the rotary mower 100 are discharged at a rear of the header 102 into a windrow 70 for later collection.

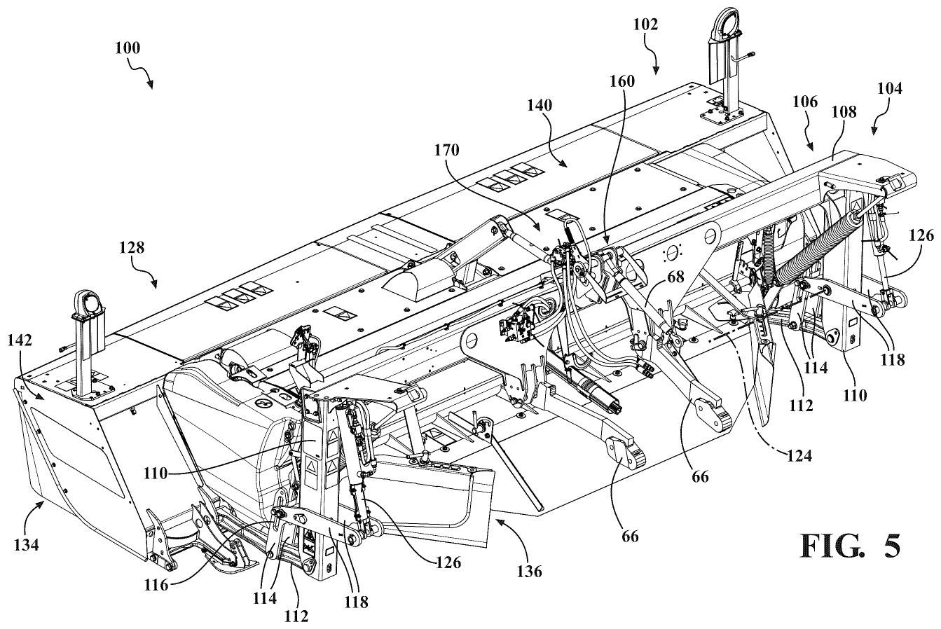

Referring to FIGS. 5-7, the rotary mower 100 includes the carrier 104. The carrier 104 includes a carrier frame 106 having a base member 108 and two side members 110 arranged on opposing ends of the base member 108. The carrier 104 further includes a pair of float links 112 extending between a first end 112A and a second end 112B. Each of the float links 112 are pivotably coupled to one of the side members 110 and to the header 102. More specifically, the first end 112A of the float link 112 is pivotably coupled to the carrier frame 106 and the second end 112B of the float link 112 is pivotably coupled to the header 102. The float links 112 control the relative movement between the header 102 and the carrier frame 106. The carrier 104 further includes a sliding link 114 and a limiter link 118. The sliding link 114 has a first end 114A operably coupled to the header 102 and defines a guide slot 116 proximate a second end 114B of the sliding link 114. The sliding link 114 is pivotably coupled to one of the float links 112 such that movement of the header 102 relative to the carrier frame 106 causes coordinated movement of the sliding link 114. The sliding link 114 is positioned nearer to the first end 112A of the float link 112 than to the second end 112B of the float link 112. Said differently, a distance between the first end 114A of the sliding link 114 and the first end 112A of the float link 112 is less than a distance between the first end 114A of the sliding link 114 and the second end 112B of the float link 112.

The guide slot extends between a first end 116A and a second end 116B. The limiter link 118 has a first end 120 and a second end 122 spaced from the first end 120. The first end 120 of the limiter link 118 is movably coupled to the guide slot 116 for pivoting and sliding movement relative to the sliding link 114. The first end 120 of the limiter link 118 is slidable along a length of the guide slot 116 between engagement with the first end 116A of the guide slot 116 and engagement with the second end 116B of the guide slot 116. Furthermore, the limiter link 118 is pivotably coupled to one of the side members 110 of the carrier frame 106 at a pivot axis 124 between the first end 120 and the second end 122. The limiter link 118 is arranged such that a distance between the pivot axis 124 and the first end of the limiter link 120 is less than a distance between the pivot axis 124 and the second end 122 of the limiter link 118.

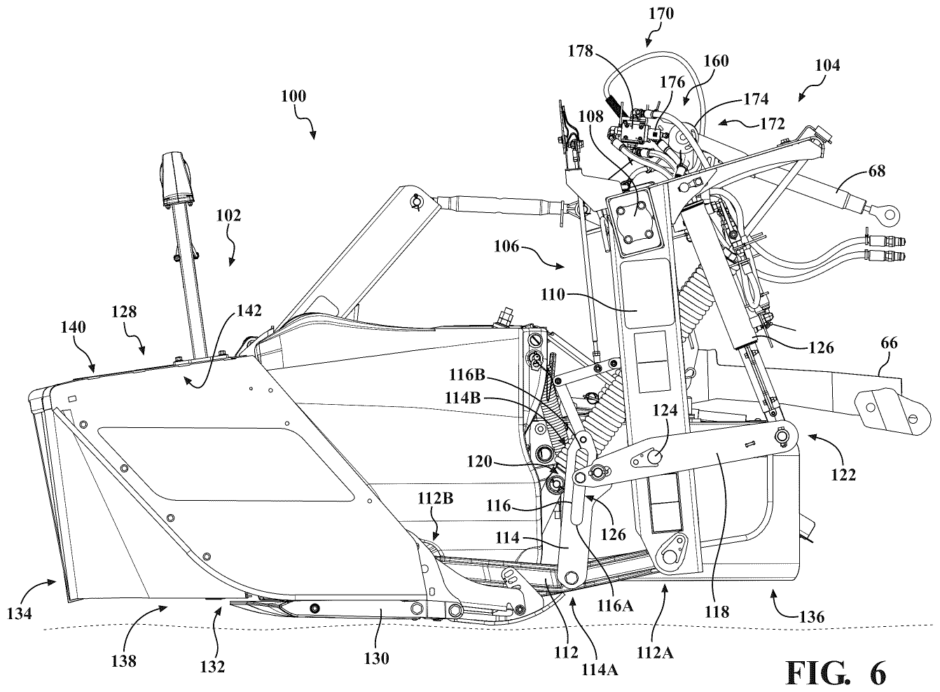

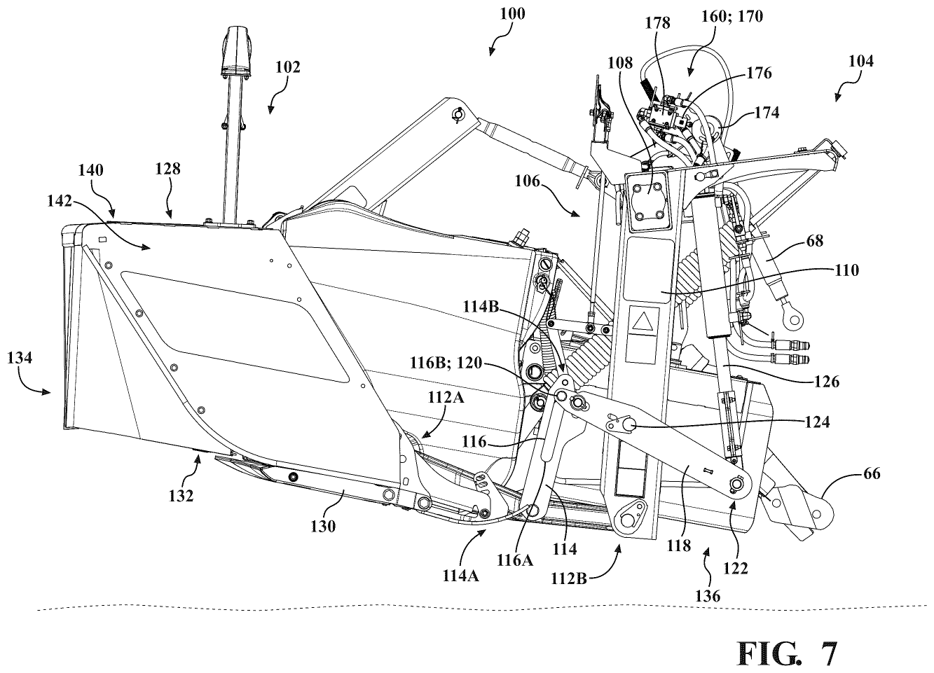

A lift actuator 126 is coupled between the carrier frame 106 and the second end 122 of the limiter link 118. The lift actuator 126 is movable between a retracted position (FIG. 6) and an extended position (FIG. 7) to effect coordinated movement of the limiter link 118 and the float links 112. In this way, a couple moment is formed by the first end 120 and the second end 122 of the limiter link 118 as it pivots about the pivot axis 124. Movement of the lift actuator 126 from the retracted position toward the extended position moves the first end 120 of the limiter link 118 toward engagement with the second end 116B of the guide slot 116.

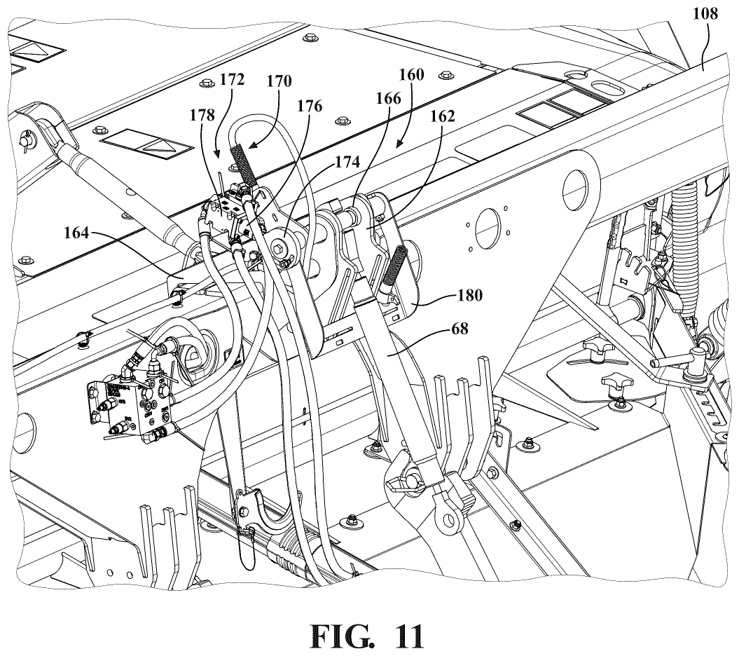

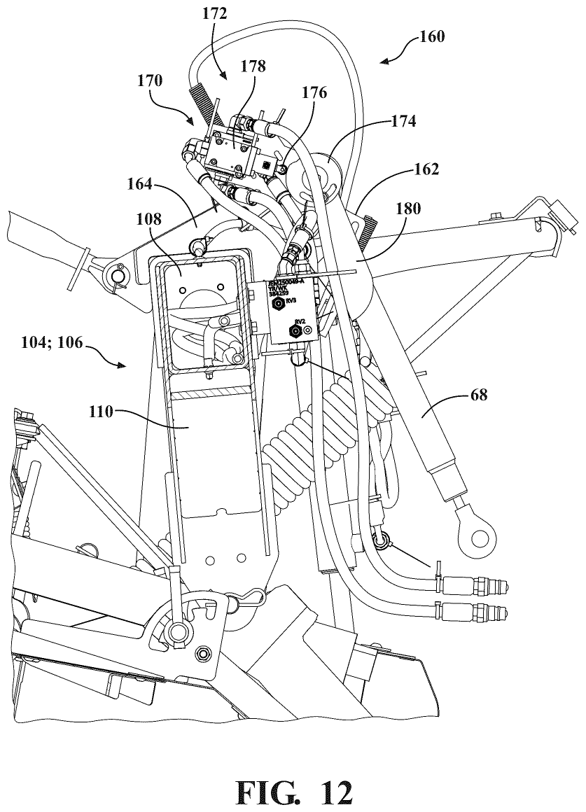

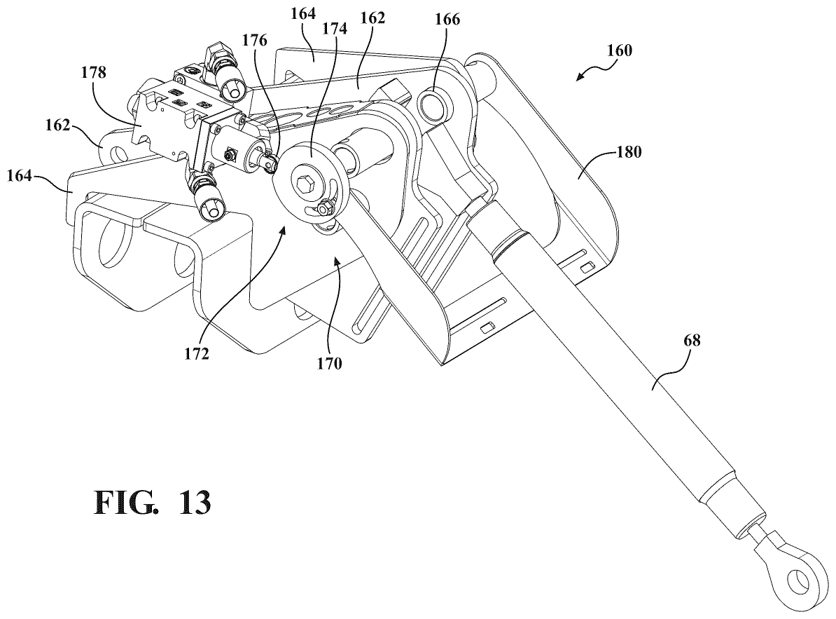

Best shown in FIGS. 11-14, the carrier 104 further includes a top link receiver 160 coupled to the base member 108 of the carrier frame 106. The top link receiver 160 is pivotably coupled to the top link 68 above the lifting arms 66. As the lifting arms 66 raise and lower the carrier 104, the angle of the top link 68 and the carrier frame 106 changes in a corresponding manner. In FIGS. 11, 12, and 14, the rotary mower 100 is shown in the raised position, and in FIG. 13, the rotary mower 100 is shown in the lowered position. The top link receiver 160 includes two lateral plates 162 and two reinforcing plates 164. An opening 166 is defined between the lateral plates 162 and the reinforcing plates 164 with one end of the top link 68 arranged in the opening 166. One of the lateral plates 162 and one of the reinforcing plates 164 are arranged on each opposing side of the opening 166.

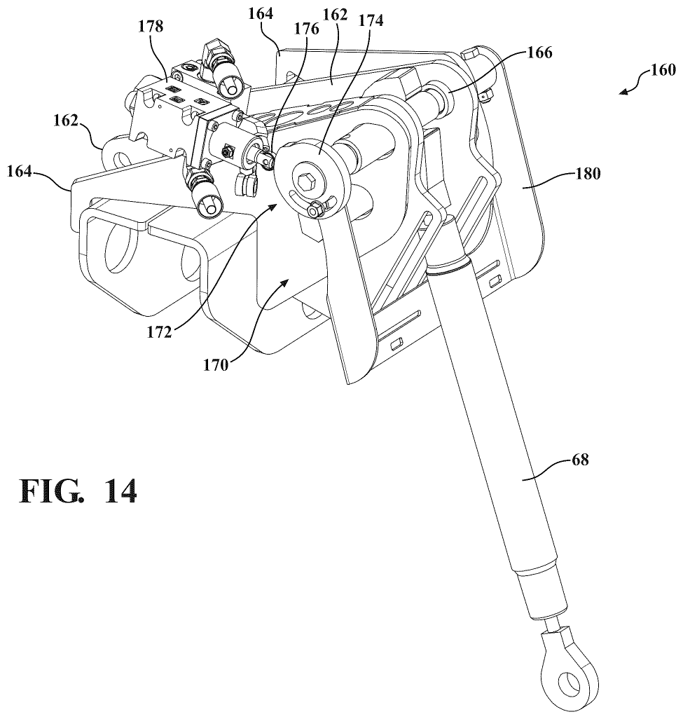

With continued reference to FIGS. 13 and 14, the implementation of the rotary mower 100 illustrated herein may further include a guide mechanism 170 coupled to the carrier frame 106 and configured to control movement of the lift actuator 126 based on a position of the carrier frame 106 relative to the tractor 50. The guide mechanism 170 includes a position sensor 172 configured to produce an output in response to the carrier frame 106 being moved to the raised position by lifting arms 66 of the tractor 50. As the lifting arms 66 move upward to lift the carrier 104, movement of the carrier frame 106 into the raise position is sensed by the position sensor 172, which generates an output responsive to the movement. In a first implementation of the position sensor 172, the position sensor 172 includes a cam 174 and a follower 176 operably engaged with the cam 174 and configured to produce the output. As will be discussed below, the cam 174 rotates as the carrier frame 106 is raised and lowered by the lifting arms 66, i.e., moves relative to the tractor 50. As the cam 174 rotates, the follower 176 is displaced according to a distance from a cam surface to the axis of rotation. Displacement of the follower 176 is the output of the position sensor 170. Here, moving the carrier frame 106 from the lowered position (FIG. 13) to the raised position (FIG. 14) displaces the follower 176 away from the axis of rotation of the cam 174. Said differently, the surface of the cam 174 displaces the follower 176 away from the axis of rotation for the cam 174 when the carrier frame 106 is moved from the lowered position to the raised position.

The guide mechanism 170 may further include a valve 178 operable by the follower 176 to actuate the lift actuator 126. The valve 178 is coupled to the carrier frame 106 and operably coupled to the follower 176 such that displacement of the follower 176 (i.e., the output of the position sensor 172) is received by the valve 178. The implementation shown in FIGS. 13 and 14 is arranged such that when the carrier frame 106 is moved to the raised position, the follower 176 is displaced toward the valve 178, which operates the valve 178, thereby actuating the lift actuator 126. In some applications, the position of the carrier frame 106 relative to the tractor 50 that corresponds to the raised position of the carrier frame 106 may be varied to suit particular conditions such as the type of header (e.g., a rotary header or a draper header) or field and crop characteristics. The relative position of the carrier frame 106 and the tractor 50 corresponding to the raised position of the carrier frame 106 may be adjusted with the position sensor 172. To this end, the cam 174 may be adjustable to vary the relative position of the carrier frame 106 and the tractor 50 corresponding to the raised position of the carrier frame 106. More specifically, the cam 174 may be rotationally positioned such that the follower 176 is displaced and operates the valve 178 at a lower position of the carrier frame 106 to actuate the lift actuator 126 sooner.

The position sensor 172 may further include a link arm 180 configured to be fixedly coupled to the top link 68. coupled to the top link receiver 160. The link arm 180 is pivotable relative to the top link receiver 160 so as to pivot in a corresponding manner with the top link 68. More specifically, when the rotary mower 100 is in the raised position and the top link 68 is positioned at a first angle relative to the carrier frame 106, the link arm 180 is arranged at a substantially similar first angle relative to the carrier frame 106. The link arm 180 is likewise operably coupled to the cam 174 such that pivoting movement of the link arm 180 rotates the cam 174. In this way, relative movement between the top link 68 and the carrier frame 106 is sensed by the position sensor 172 and the corresponding movement of the link arm 180. Movement of the link arm 180 rotates the cam 174, which displaces the follower 176 to produce the output used to operate the valve 178 and actuate the lift actuator 126.

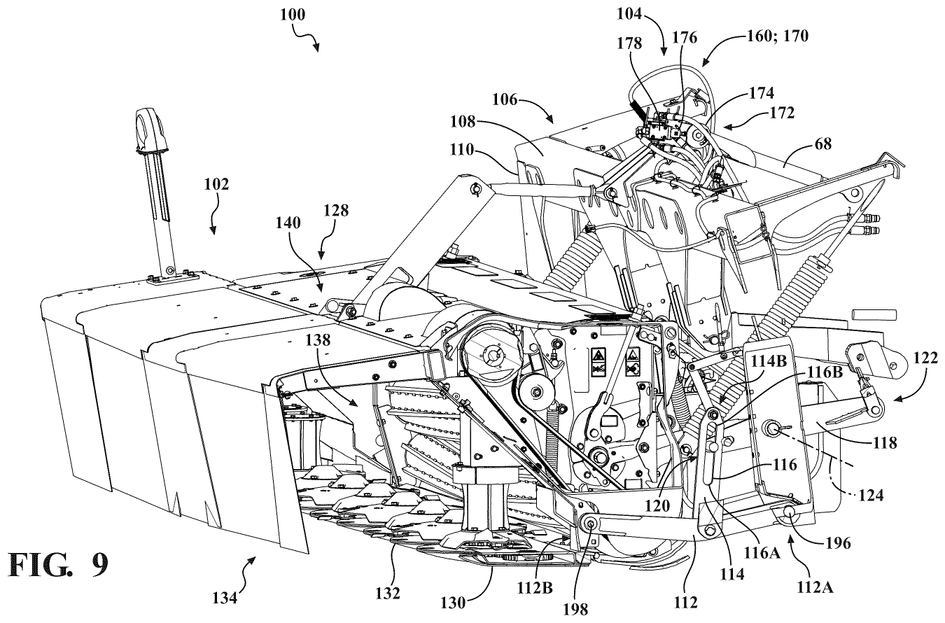

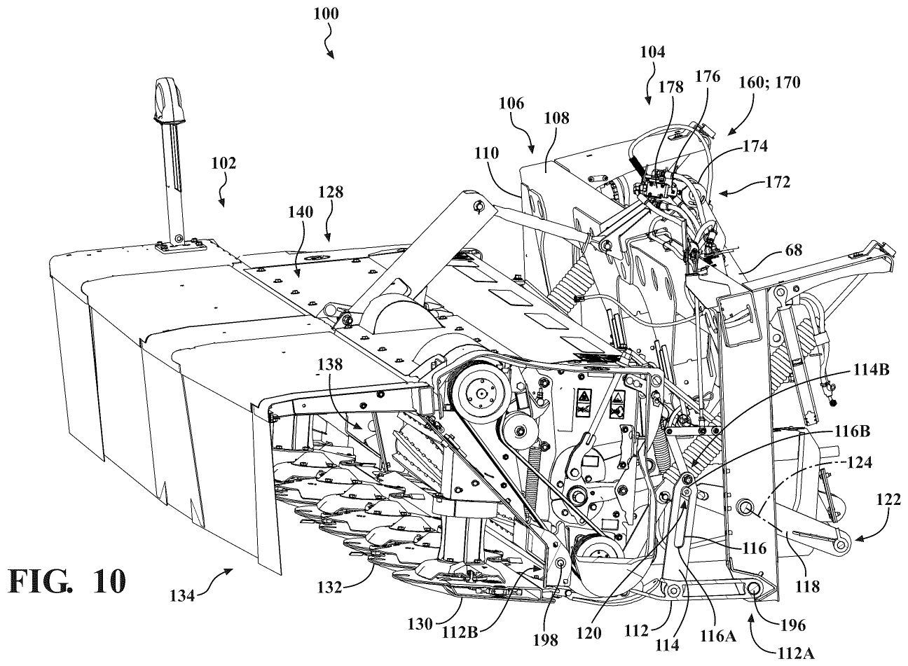

Turning to FIGS. 5-10, the header 102 includes a header frame 128, the header frame 128 being coupled to the carrier frame 106 by the float links 112. Said differently, a first end of the float links 112 is coupled to the carrier frame 106 and a second end of the float links 112 is coupled to the header frame 128. The header 102 further includes a cutter bar 130 coupled to the header frame 128. Best shown in FIGS. 9 and 10, The cutter bar 130 includes a plurality of rotary cutters 132, which are driven by the tractor PTO. The cutter bar 130 is operable to cut crops that are received in the header 102. The header frame 128 has an inlet portion 134 on a front side of the header 102, a discharge portion 136 at a rear side of the header 102, and a cutter portion 138, in which the cutter bar 130 is disposed, arranged between the inlet portion 134 and the discharge portion 136. The header frame 128 further includes a top wall 140 that extends between the inlet portion 134 and the cutter portion 138. During operation, as the rotary mower 100 progresses forward, crops are received in the inlet portion 134 and into the cutter portion 138 where the crops are cut by the cutter bar 130. Cut crops enter the discharge portion 136 and discharged through the rear side of the header frame 128.

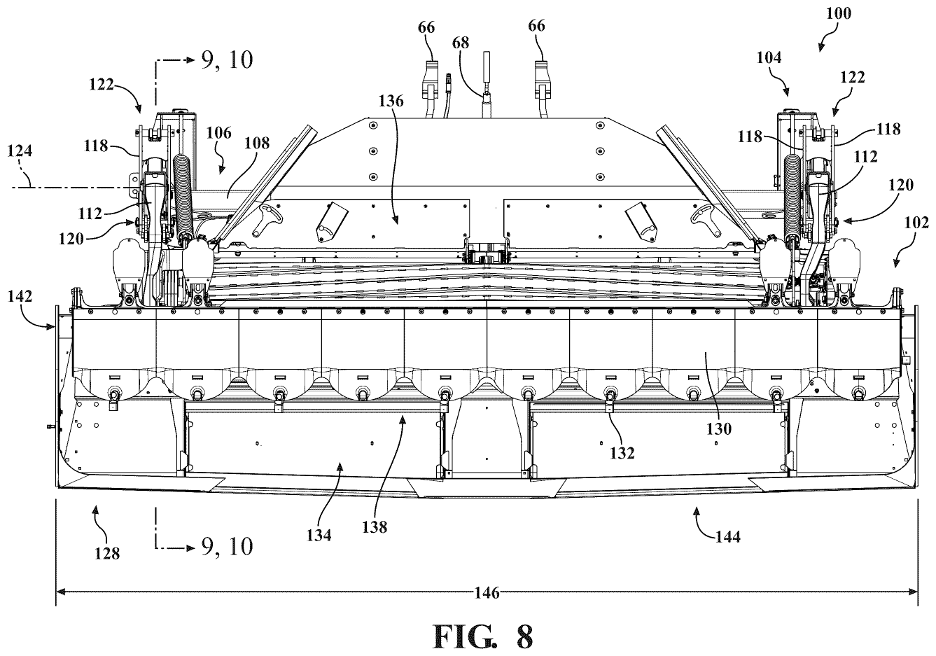

Best shown in FIG. 8, the inlet portion 134 includes two side inlet walls 142 spaced from each other to form an inlet opening 144 having an inlet width 146. The inlet opening 144 is arranged at the frontmost end of the rotary mower 100 and receives uncut crops as the rotary mower 100 is advanced forward by the tractor 50. The header frame 128 may further include rear header walls 148 at a rear of the header frame 128. The rear header walls 148 guide crops processed in the cutter portion 138 toward the discharge portion 136. The side inlet walls 142, the rear header walls 148, and the top wall 140 cooperate to enclose the inlet portion 134 and the cutter portion 138 of the header frame 128. As the tractor 50 continues to advance the rotary mower 100 forward, crops move from the inlet portion 134 into the cutter portion 138.

Returning to FIGS. 3, 6, 9, and 10, as mentioned above, the header 102 is pushed along the ground by the tractor 50 during operation and is able to float relative to the carrier 104 to closely follow contours of the ground and maintain a steady height above the ground. More specifically, the header 102 is pushed along the ground and when a raised or protruding obstacle (e.g., a rock) is encountered, the header frame 128 is able to move upward and slightly rearward to “float” over the obstacle. Conversely, when the header 102 encounters a lowered obstacle (e.g., a depression or divot in the ground), the header frame 128 is able to “float” downward and slightly rearward to maintain the cutter bar 130 close to the ground. This floating motion is generally guided by the float links 112, which are pivotably coupled between the carrier frame 106 and the header frame 128. Each of the float links 112 pivots about the first end 112A at a first pivot point 196 on the side member 110 of the carrier frame 106, and because the float links 112 are generally parallel to the ground, an arcuate path of a second pivot point 198 at the second end 112B of the float link 112 and the header frame 128 causes the header 102 to move vertically with only a slight rearward displacement. Cutting performance of the rotary mower 100 is enhanced by reducing the distance between the first pivot point 196 and the ground, which allows the floating motion of the header 102 to be mostly vertical with reduced rearward motion. As the header 102 floats up and down during operation, the first end 120 of the limiter link 118 slides up and down in the guide slot 116.

Turning to FIGS. 4, 7, and 10, during use the rotary mower 100 is moved into the raised position, which lifts the rotary mower 100 off the ground to a height generally above the height of the windrows 70. This allows the tractor 50 to perform a headland turn without the rotary mower 100 disturbing the windrows 70. Additionally, the raised position is used during transport of the rotary mower 100. When the lifting arms 66 raise the carrier 104, the header frame 128 is able to float downward, which reduces clearance between the bottom of the header frame 128 and the ground. In order to increase the clearance between the bottom of the header frame 128 and the ground, the lift actuators 126 are actuated toward the extended position, which pivots the limiter link 118 about the pivot axis 124 and moves the first end 120 of the limiter link 118 toward the second end 116B of the guide slot 116. Engagement between first end 120 of the limiter link 118 and the second end 116B of the guide slot 116 prevents downward movement of the header frame 128 relative to the carrier frame 106. When the first end 120 of the limiter link 118 is positioned near the second end 114B of the sliding link 114 and engaged with the second end 116B of the guide slot 116, the header frame 128 is prevented from floating downward. Said differently, the first end 120 of the limiter link 118 limits the floating movement of the header 102, thereby increasing the clearance between the bottom of the header frame 128 and the ground.

Continuing, when the rotary mower 100 is in the raised position and the operator wishes to resume harvesting, the operator commands the lifting arms 66 to lower the carrier frame 106. As the carrier 104 moves down, movement of the top link 68 is sensed by the position sensor 172, which generates an output that operates the valve 178. Operation of the valve 178 actuates the lift actuator 126 to move from the extended position to the retracted position, which pivots the limiter link 118 about the pivot axis 124 by moving the second end 122 of the limiter link 118 upward. The upward movement of the second end 122 of the limiter link 118 causes the first end 120 of the limiter link 118 to move downward in a corresponding manner. When the first end 120 of the limiter link 118 moves downward, the sliding link 114 likewise moves downward relative to the carrier frame 106, which pivots the float link 112 and allows header frame 128 to move downward. Once the header 102 has reached the lowered position the header frame 128 and the float link 112 move the sliding link 114 upwards such that the first end 120 of the limiter link 118 is near the middle of the guide slot 116.

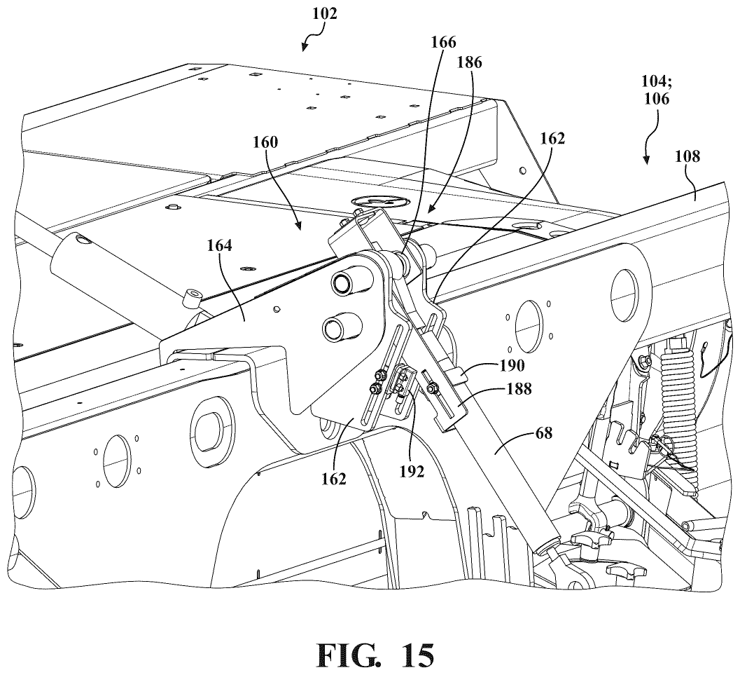

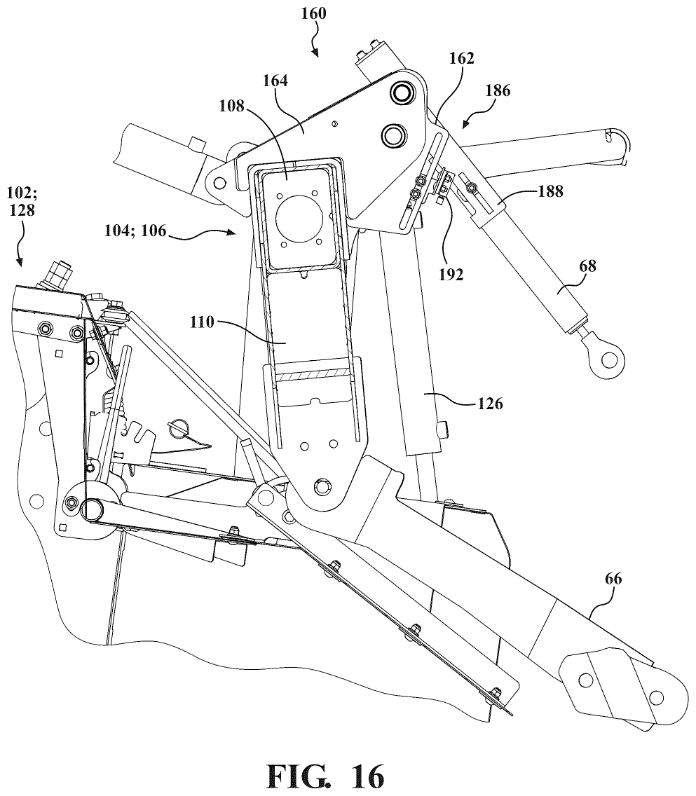

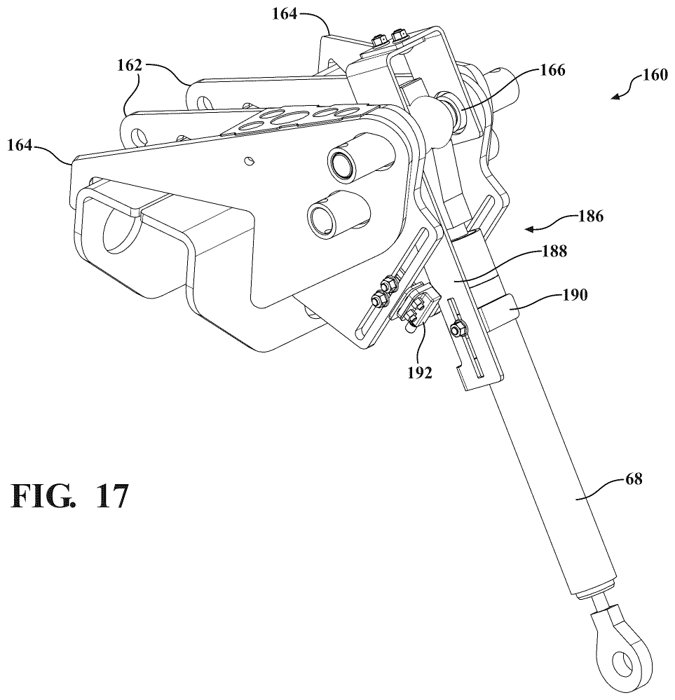

Turning now to FIGS. 15-18, a second implementation of the guide mechanism 186 and a control system are shown. As with above, the carrier 104 includes the top link receiver 160 coupled to the base member 108 of the carrier frame 106. The top link receiver 160 is pivotably coupled to the top link 68 above the lifting arms 66. As the lifting arms 66 raise and lower the carrier 104, the angle of the top link 68 and the carrier frame 106 changes in a corresponding manner. A link arm 188 is fixedly coupled to the end of the top link 68 and pivotably coupled to the top link receiver 160. The link arm 188 is pivotally coupled to the top link receiver 160 and pivots in a corresponding manner with the top link 68. More specifically, when the rotary mower 100 is in the raised position with the top link 68 at a first angle relative to the carrier frame 106, the link arm 188 is arranged at a substantially similar first angle relative to the carrier frame 106. The link arm 188 extends along a portion of the top link 68 and may include an adjustable clamp member 190. The adjustable clamp member 190 engages the top link 68 to facilitate coordinated movement with the top link 68. The adjustable clamp member 190 is movable in a slot to accommodate top links 68 having various configurations that may differ from the top link 68 illustrated here.

The guide mechanism 186 further includes a position sensor 192 coupled to the top link receiver 160. Here, the position sensor 192 is coupled to one of the lateral plates 162 and adjustable in a slot to accommodate various tractors 50 and top links 68. The position sensor 192 is configured to generate an electrical signal when the rotary mower 100 is in the raised position by sensing a distance to the top link 68. As shown in FIGS. 13 and 14, when the rotary mower 100 is in the raised position (FIG. 14) the top link 68 is nearer to the position sensor 192 than when the rotary mower is in the lowered position (FIG. 13). The position sensor 192 may be implemented as an inductive sensor that generates an electrical signal corresponding to a distance between the link arm 188 and the position sensor 192. Alternatively, the position sensor 192 may be implemented as a Hall effect sensor, which is configured to generate a signal corresponding to a distance between the position sensor 192 and a magnetic element (not shown) coupled to the top link 68 or the link arm 188. The distance between the position sensor 192 and the link arm 188 can be used to identify when the top link 68 is close to the position sensor 192, which corresponds to the rotary mower 100 being in the raised position. It should be appreciated that the position sensor 192 may be configured to sense the position of the top link 68 directly as well as by sensing the position of the link arm 188. The sensor 192 may further be arranged and mounted differently than shown and described herein. As will be discussed below, the position sensor 192 is in electrical communication with a controller 194, which is configured to generate control signals that coordinate or automate adjustments of the rotary mower 100.

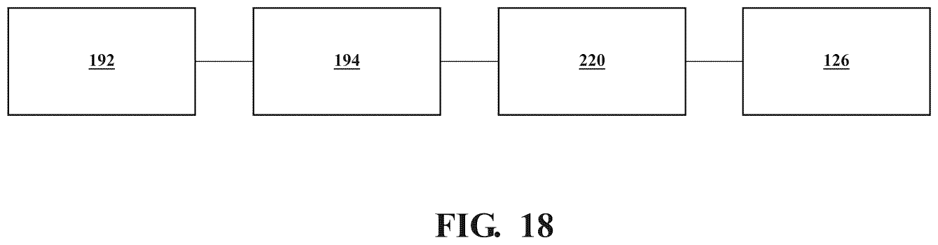

Turning to FIG. 18, the rotary mower 100 may further include a controller 194, which is configured to generate control signals that coordinate or automate adjustments of the rotary mower 100. Automation of the controls advantageously eliminates the need for an operator of the tractor to operate multiple controls simultaneously as well as reduces risk associated with unintentionally missed operation. As illustrated in FIG. 18, the controller 194 is in electrical communication with one or more control valves 220, which are operable to direct the flow of hydraulic fluid to actuators on the rotary mower 100. The controller 194 may be implemented using a series of logic relays that control the operation. Alternatively, the controller 194 may be implemented as a solid state controller having a set of instructions controlling the operation stored in a memory.

Similar to the valve 178 described above in connection with the first implementation of the guide mechanism 170, control valves 220 are fluidly coupled to the lift actuators 126 and are operable to effect movement of the lift actuators 126 between the extended position and the retracted position. In some instances, the controller 194 may receive control signals from an operator of the tractor 50 to operate the control valve 220. The controller 194 is configured to receive signals from sensors, such as the position sensor 192, to operate the control valve 220. Here, the controller 194 receives a signal from the position sensor 192 indicating the top link 68 is close to the position sensor 192, which corresponds to the lifting arms 66 having raised the carrier 104 to the raised position. When the controller 194 receives the signal that the top link 68 is close to the position sensor 192, the controller operates the control valve 220 to move the lift actuator 126 toward the extended position. As described above, when the lift actuator 126 is in the extended position, the floating movement of the header 102 is limited, thereby preventing the header 102 from floating downwards.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

What is claimed is:

1. An agricultural implement for use with an agricultural machine, the agricultural implement comprising:
a carrier frame configured to be coupled to the agricultural machine;
a header frame having a cutter bar;
a float link having a first end pivotably coupled to the carrier frame and a second end pivotably coupled to the header frame to movably couple the header frame to the carrier frame;
a sliding link having a first end operably coupled to the header frame and defining a guide slot proximate a second end; and
a limiter link having a first end movably coupled to the guide slot and a second end spaced from the first end, wherein the limiter link is pivotably coupled to the carrier frame between the first end and the second end and movable to control relative movement between the header frame and the carrier frame.

2. The agricultural implement of claim 1, further comprising a lift actuator coupled between the carrier frame and the second end of the limiter link, wherein the lift actuator is movable between a retracted position and an extended position to pivot the limiter link relative to the carrier frame.

3. The agricultural implement of claim 2, further comprising a guide mechanism coupled to the carrier frame and configured to control movement of the lift actuator based on a position of the carrier frame relative to the agricultural machine.

4. The agricultural implement of claim 3, wherein the guide mechanism includes a position sensor configured to produce an output in response to the carrier frame being moved to a raised position by the agricultural machine.

5. The agricultural implement of claim 4, wherein the position sensor includes a cam and a follower operably engaged with the cam.

6. The agricultural implement of claim 5, wherein the cam is adjustable to vary the relative position of the carrier frame and the agricultural machine corresponding to the raised position of the carrier frame.

7. The agricultural implement of claim 5, wherein the guide mechanism further includes a hydraulic valve operable by the follower to actuate the lift actuator.

8. The agricultural implement of claim 4, wherein the guide mechanism includes a top link receiver coupled to the carrier frame and configured to be pivotably coupled to a top link, and wherein the position sensor further includes a link arm configured to be fixedly coupled to the top link.

9. The agricultural implement of claim 2, wherein the sliding link is pivotably coupled to the float link such that movement of the header frame relative to the carrier frame causes coordinated movement of the sliding link.

10. The agricultural implement of claim 2, wherein the guide slot extends between a first end and a second end, and wherein engagement between first end of the limiter link and the second end of the guide slot prevents downward movement of the header frame relative to the carrier frame.

11. The agricultural implement of claim 10, wherein movement of the lift actuator from the retracted position toward the extended position moves the first end of the limiter link toward engagement with the second end of the guide slot.

12. The agricultural implement of claim 11, wherein continued movement of the lift actuator toward the extended position when the first end of the limiter link is engaged with the second end of the guide slot pivots the float link to raise the header frame relative to the carrier frame.

13. A lifting system for an agricultural implement having a carrier frame and a header frame, the lifting system comprising:
a float link having a first end pivotably coupled to the carrier frame and a second end pivotably coupled to the header frame to movably couple the header frame to the carrier frame;
a sliding link having a first end operably coupled to the header frame and defining a guide slot proximate a second end; and
a limiter link having a first end movably coupled to the guide slot and a second end spaced from the first end, wherein the limiter link is pivotably coupled to the carrier frame between the first end and the second end and movable to control relative movement between the header frame and the carrier frame.

14. The lifting system of claim 13, wherein a lift actuator coupled between the carrier frame and the second end of the limiter link, wherein the lift actuator is movable between a retracted position and an extended position to pivot the limiter link relative to the carrier frame.

15. The lifting system of claim 14, wherein the sliding link is pivotably coupled to the float link such that movement of the header frame relative to the carrier frame causes coordinated movement of the sliding link.

16. The lifting system of claim 15, wherein the sliding link is positioned nearer to the first end of the float link than to the second end of the float link.

17. The lifting system of claim 14, wherein the guide slot extends between a first end and a second end, and wherein engagement between first end of the limiter link and the second end of the guide slot prevents downward movement of the header frame relative to the carrier frame.

18. The lifting system of claim 17, wherein movement of the lift actuator from the retracted position toward the extended position moves the first end of the limiter link toward engagement with the second end of the guide slot.

19. The lifting system of claim 14, further comprising a guide mechanism coupled to the carrier frame and configured to control movement of the lift actuator based on a position of the carrier frame relative to the agricultural machine.

20. The lifting system of claim 13, wherein the limiter link is pivotable about a pivot axis, and wherein a distance between the pivot axis and the first end of the limiter link is less than a distance between the pivot axis and the second end of the limiter link.
